(19) United States
(12) Patent Application Publication
(10) Pub. No.: US 2026/0286033 A1
(43) Pub. Date: Sep. 24, 2026

(54) POLYFUNCTIONAL VINYL RESIN AND METHOD FOR PRODUCING SAME

(71) Applicant: NIPPON STEEL CHEMICAL & MATERIAL CO., LTD., Tokyo (JP)

(72) Inventor: Masahiro Soh, Tokyo (JP)

(73) Assignee: NIPPON STEEL CHEMICAL & MATERIAL CO., LTD., Tokyo (JP)

(21) Appl. No.: 18/874,072

(22) PCT Filed: Jun. 12, 2023
(86) PCT No.: PCT/JP2023/021783

§ 371 Date: Dec. 11, 2024

(30) Foreign Application Priority Data
Jun. 30, 2022 (JP) 2022-106378

(51) Int. Cl. C08F 290/14; B32B 5/02; B32B 15/14; B32B 15/20; B32B 27/12; B32B 27/30; C08J 5/24

(52) U.S. Cl. CPC C08F 290/14; B32B 5/024; B32B 15/14; B32B 15/20; B32B 27/12; B32B 27/302; C08J 5/244; B32B 2260/021; B32B 2260/046; B32B 2262/101; B32B 2307/204; B32B 2307/306; C08J 2351/08

(57) ABSTRACT

To provide a resin material having high heat resistance and adhesiveness while having low relative permittivity and dielectric tangent. A polyfunctional vinyl resin represented by the following general formula (1), wherein each R¹ represents a hydrocarbon group having 1 to 8 carbon atoms, each R² represents a hydrogen atom or a group represented by formula (2) or formula (3); and each X represents a hydrogen atom or a vinyl group-containing aromatic group represented by formula (1a)

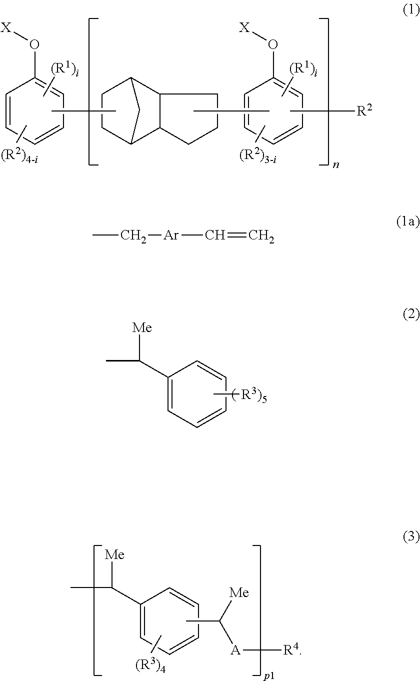

### TECHNICAL FIELD

The present invention relates to a polyfunctional vinyl resin and a polyfunctional vinyl resin composition having low dielectric tangent as well as high heat resistance and adhesion properties useful for printed substrates, sealing materials, casting materials, and the like of electronic devices, and a cured product thereof.

### BACKGROUND ART

Information communication in high frequency bands has been actively performed along with an increase in the amount of information communication in recent years, and it has been required to have superior electric properties, in particular, low relative permittivity and low dielectric tangent in order to reduce transmission loss in high frequency bands. Further, since printed substrates or electronic components using an electrical insulation material are exposed to solder reflow at high temperatures during mounting, a material having high heat resistance, that is, exhibiting a high glass transition temperature has been desired. In particular, lead-free solder having a high melting point has recently been used due to environmental concerns. Hence, a demand for an electrical insulation material having higher heat resistance has increased. To meet such demands, cured resins using vinyl benzyl ether resins with various chemical structures have conventionally been suggested.

As such cured resins, for example, cured resins such as a divinyl benzyl ether resin of bisphenol or a phenol novolac-type polyvinyl benzyl ether resin have been suggested (Patent Literature 1 and Patent Literature 2). However, these vinyl benzyl ether resins cannot provide sufficient properties in initial dielectric properties, and it cannot be said that the heat resistance thereof is sufficiently high.

Some vinyl benzyl ether compounds and resins having a specific structure have been suggested as vinyl benzyl ether compounds and resins in which those properties are improved, and attempts have been made to improve heat resistance (Patent Literature 3, Patent Literature 4, and Patent Literature 5). However, it cannot be said yet that the improvement in properties is sufficient, and further improvement in properties has been demanded. Thus, those vinyl benzyl ether compounds and resins are insufficient as mounting materials in terms of reliability and processability.

A polyfunctional vinyl resin composition that contains a polyfunctional vinyl resin obtained by subjecting at least one hydroxyl group selected from the group consisting of a phenol aralkyl resin, a naphthol aralkyl resin, a biphenyl-type phenol novolac resin, and a biphenyl-type naphthol novolac resin to vinyl benzyl etherification is disclosed (Patent Literature 6). However, the vinyl benzyl etherified polyfunctional vinyl resin synthesized according to the method disclosed in Patent Literature 6 has a large total halogen content and a large amount of remaining vinyl aromatic halomethyl compound, and is thus unsatisfactory as an insulation material having dielectric tangent and heat resistance corresponding to high frequencies after severe thermal history. The resin is also undesirable in terms of moldability, because molding defects easily occur.

It is also known to subject a phenolic hydroxyl group of a polyfunctional phenylene ether oligomer obtained by reacting a polyhydric phenol having 3 or more and less than 9 phenolic hydroxyl groups per molecule and having an alkyl group or an alkylene group at 2- and 6-positions of at least one phenolic hydroxyl group among them with a monovalent phenolic compound, to vinyl benzylation (Patent Literature 7). However, the vinyl benzyl ether resin obtained by this technique has drawbacks such that the molding temperature is high due to its high viscosity and when the vinyl benzyl ether resin is exposed to high temperatures in an air atmosphere, its dielectric tangent largely deteriorates. In addition, the adhesion force with a conductor layer is unsatisfactory, and there is a need for improvement.

Thus, conventional vinyl benzyl ether compounds and resins do not give cured products that satisfy the heat resistance required for electrical insulation material applications, in particular, electrical insulation material applications corresponding to high frequencies and a low dielectric tangent, and are also insufficient in terms of adhesion properties with a conductor layer, reliability, and processability.

### CITATION LIST

### Patent Literatures

Patent Literature 1: JP 63-68537 A
Patent Literature 2: JP 64-65110 A
Patent Literature 3: JP 1-503238 A
Patent Literature 4: JP 9-31006 A
Patent Literature 5: JP2004-323730 A
Patent Literature 6: JP2003-306591 A
Patent Literature 7: JP2007-308685 A

### SUMMARY OF INVENTION

The problems of the present invention are to provide a vinyl resin and a resin composition that give a cured product having a high glass transition temperature while having low relative permittivity and dielectric tangent and are further excellent in adhesiveness with a conductor layer, and an object of the present invention is to provide a resin composition, a cured product, or a material containing the same that can be used as dielectric materials, insulation materials, and heat-resistant materials in the fields of electrical and electronic industries, space and aircraft industries, and the like.

To solve the above problems, the present inventors have intensively studied, and as a result, found that the problems can be solved by a specific polyfunctional vinyl resin represented by the following general formula (1) and a resin composition containing the polyfunctional vinyl resin, thereby completing the present invention.

In other words, the present invention relates to a polyfunctional vinyl resin represented by the following general formula (1):

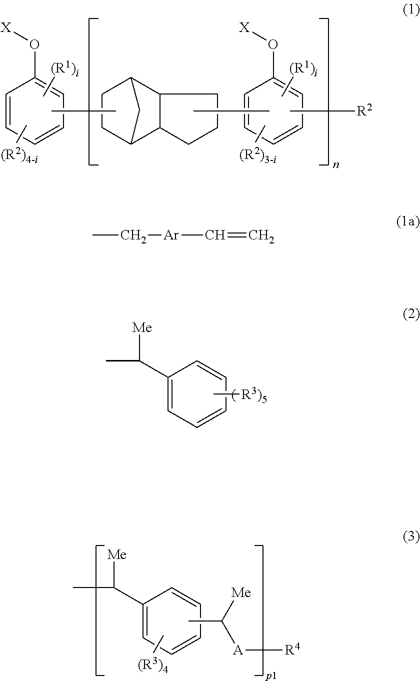

wherein
each R¹ independently represents a hydrocarbon group having 1 to 8 carbon atoms;
each R² independently represents a hydrogen atom, a group represented by formula (2), or a group represented by formula (3), and at least one R² is represented by formula (2) or formula (3);
each R³ independently represents a hydrogen atom or a hydrocarbon group having 1 to 8 carbon atoms;
each R⁴ independently represents a hydrogen atom or a group represented by formula (2);
A represents a residue obtained by removing two R² from the formula (1) and each R² in the residue independently represents a hydrogen atom or a group represented by formula (2);
Me represents a methyl group;
each X independently represents a hydrogen atom or a vinyl group-containing aromatic group represented by the formula (1a) and at least one is a vinyl group-containing aromatic group;
Ar represents an aromatic ring;
i is an integer of 0 to 2; and
each of n and p1 represents the number of repetitions and an average value thereof is a number of 0 to 5.
Ar in the formula (1a) is preferably an aromatic ring selected from the group consisting of a benzene ring, a naphthalene ring, and a biphenyl ring, and the aromatic ring Ar is unsubstituted or has one or more substituents.
R¹ is preferably a methyl group or a phenyl group, and i is preferably 1 or 2.

The present invention also relates to a polyfunctional vinyl resin obtained by vinylation of a polyvalent hydroxy resin represented by the following general formula (4):

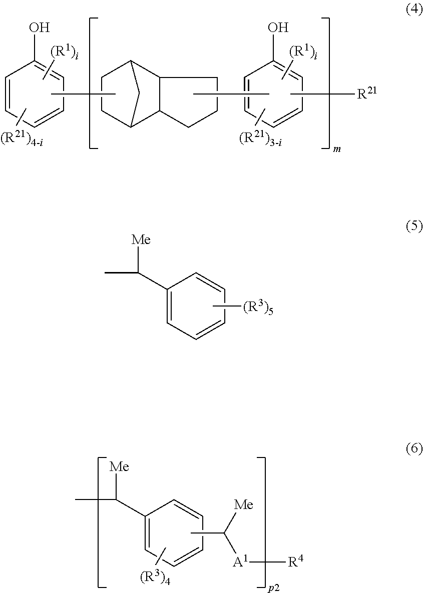

wherein
each R¹ independently represents a hydrocarbon group having 1 to 8 carbon atoms;
each R²¹ independently represents a hydrogen atom, a group represented by formula (5), or a group represented by formula (6), and at least one is formula (5) or formula (6);
each R³ independently represents a hydrogen atom or a hydrocarbon group having 1 to 8 carbon atoms;
each R⁴ independently represents a hydrogen atom or a group represented by formula (5);
A¹ represents a residue obtained by removing two R²¹ from the formula (4) and each R²¹ in the residue independently represents a hydrogen atom or a group represented by formula (5);
Me represents a methyl group;
i is an integer of 0 to 2; and
each of m and p2 represents the number of repetitions and an average value thereof is a number of 0 to 5.

The present invention also relates to a polyfunctional vinyl resin composition containing the polyfunctional vinyl resin and a radical polymerization initiator as essential components.

The present invention also relates to a cured product obtained by curing the resin composition, which is a material for circuit substrates, a sealing material, a prepreg, a resin sheet, or a laminated board using the resin composition.

The present invention also relates to a method for producing the polyfunctional vinyl resin including reacting the polyvalent hydroxy resin and a halogenated methyl group-containing aromatic vinyl compound represented by the following general formula (10):

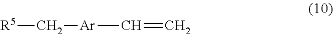

wherein Ar represents an aromatic ring, and R⁵ represents a halogen.

The polyfunctional vinyl resin and composition of the present invention, and a cured product obtained by further curing the composition have high adhesion force with a conductor layer while having low relative permittivity and dielectric tangent and are useful as electronic materials for high-speed telecommunication equipment.

### BRIEF DESCRIPTION OF DRAWINGS

FIG. 1 A GPC chart of a polyfunctional vinyl resin obtained in Example 1.

FIG. 2 An IR chart of the polyfunctional vinyl resin obtained in Example 1.

FIG. 3 A GPC chart of a polyfunctional vinyl resin obtained in Example 2.

FIG. 4 A GPC chart of a polyfunctional vinyl resin obtained in Example 3.

FIG. 5 A GPC chart of a polyfunctional vinyl resin obtained in Comparative Example 1.

### DESCRIPTION OF EMBODIMENTS

Hereinafter, the present invention will be described in detail.

The polyfunctional vinyl resin of the present invention is represented by the following general formula (1)

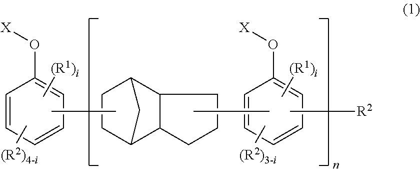

In the general formula (1), R¹ preferably independently represents a hydrocarbon group having 1 to 8 carbon atoms, an alkyl group having 1 to 8 carbon atoms, an aryl group having 6 to 8 carbon atoms, an aralkyl group having 7 to 8 carbon atoms, or an allyl group. The alkyl group may be any of linear, branched and cyclic groups, and examples thereof include a methyl group, an ethyl group, a propyl group, an isopropyl group, a n-butyl group, a t-butyl group, a hexyl group, a cyclohexyl group and a methylcyclohexyl group. Examples of the aryl group include a phenyl group, a tolyl group, a xylyl group and an ethylphenyl group. Examples of the aralkyl group include a benzyl group and an α-methylbenzyl group. Among these substituents, a phenyl group and an alkyl group having 1 to 3 carbon atoms are preferable and a methyl group is particularly preferable, from the viewpoints of availability, and reactivity of a cured product obtained.

The position of substitution with R¹ may be any of the ortho-position, the meta-position, and the para-position with respect to the aryl ether group (—O—X), and is preferably the ortho-position.

Each R² represents a hydrogen atom, or a group represented by formula (2) or formula (3), and at least one R² is represented by formula (2) or formula (3). Each R² does not necessarily represent only a substituent and represents a hydrogen atom, unlike R¹ as a substituent.

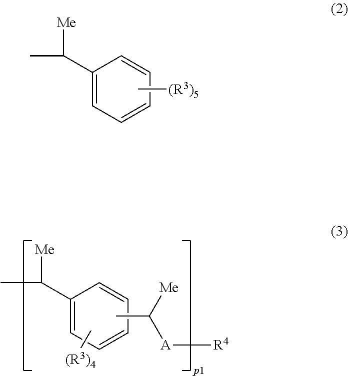

The group represented by the formula (2) is, among aromatic vinyl compounds used as raw materials when a polyvalent hydroxy resin (4) represented by general formula (4) is produced, a group derived from an aromatic monovinyl compound represented by the general formula (8a) described below, and the group represented by the formula (3) is, among the aromatic vinyl compounds, a group derived from an aromatic divinyl compound represented by the general formula (8b) described below.

Each X independently represents a hydrogen atom or a vinyl group-containing aromatic group represented by the following formula (1a), and at least one is a vinyl group-containing aromatic group which is a group derived from a halogenated methyl group-containing aromatic vinyl compound as a raw material.

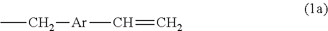

The aromatic ring Ar of the formula (1a) is preferably an aromatic ring selected from the group consisting of a benzene ring, a naphthalene ring, and a biphenyl ring, and may be unsubstituted or have one or more substituents. In the case of having a substituent, the number of substituents is preferably 1 to 4, and the substituent is preferably an alkyl group having 1 to 10 carbon atoms or an aryl group, more preferably an alkyl group having 1 to 3 carbon atoms or a phenyl group.
i is the number of substitutions by R¹, and is 0 to 2, preferably 1 or 2, more preferably 2.
n is the number of repetitions and represents a number of 0 or more, and the average value (number average) thereof is 0 to 5, preferably 1.0 to 4.0, more preferably 1.1 to 3.0, further preferably 1.2 to 2.5.

In the formula (2), each R³ represents a hydrogen atom or a hydrocarbon group having 1 to 8 carbon atoms. Examples of the hydrocarbon group having 1 to 8 carbon atoms are the same as in R¹. Each R³ also does not necessarily represent only a substituent and represents a hydrogen atom as in R², unlike R¹ as a substituent.

When an aromatic monovinyl compound represented by the formula (8a) described below is used as the raw material of the polyvalent hydroxy resin (4) represented by the general formula (4), R³ is preferably a hydrogen atom, a methyl group, or an ethyl group, and particularly preferably a hydrogen atom or an ethyl group, from the viewpoint of availability and the heat resistance of a cured product. When an aromatic divinyl compound represented by the formula (8b) described below is used as a raw material, each R³ may contain a vinyl group. The position of substitution in each R³ may be any of the ortho-position, the meta-position and the para-position, and is preferably any of the meta-position and the para-position.

Preferably, one R³ represents an ethyl group and the balance represents a hydrogen atom.

In the formula (3), A represents a residue obtained by removing two R² from the formula (1), and such two R² in the residue represent a hydrogen atom or the group represented by the formula (2). In other words, A is a divalent group having a structure similar to the general formula (1), but is not a group represented by the formula (3).
R³ has the same meaning as R³ in the formula (2).

Each R⁴ represents a hydrogen atom or the group represented by the formula (2). Each R⁴ also does not necessarily represent only a substituent and represents a hydrogen atom as in R² and R³, unlike R¹ as a substituent.
p1 is the number of repetitions and represents a number of 0 or more, and the average value (number average) thereof is 0 to 5, preferably 0.01 to 3, more preferably 0.1 to 2.0, further preferably 0.2 to 1.0, particularly preferably 0.3 to 0.8.

The polyfunctional vinyl resin (1) of the present invention preferably has a weight average molecular weight (Mw) of 400 to 5,000, more preferably 600 to 4,500, further preferably 800 to 4,000. The polyfunctional vinyl resin (1) preferably has a number average molecular weight (Mn) of 350 to 2,000, more preferably 500 to 1,500, further preferably 700 to 1,200.

The molecular weight distribution of the polyvalent hydroxy resin (4) as a raw material is kept almost as it is and the contents of an n=0 form, an n=1 form, and an n≥2 form in the general formula (1), according to GPC, are preferably respectively in the ranges of 10% by area or less, 30 to 90% by area, and 0 to 70% by area. More preferably, the contents of the n=0 form, the n=1 form, and the n 2 form are respectively in the ranges of 1 to 10% by area, 30 to 60% by area, 35 to 65% by area.

The phenolic hydroxyl group equivalent (g/eq.) is preferably 5,000 or more, more preferably 10,000 or more, further preferably 16,000 or more. A phenolic hydroxyl group equivalent of more than 10,000 exceeds the substantially measurable amount of hydroxyl groups, and this indicates that the phenolic hydroxyl groups in the polyvalent hydroxy resin as the raw material are almost completely vinylated.

The vinyl equivalent (g/eq.) is preferably 300 or more, more preferably 350 or more, further preferably 400 or more. On the other hand, the upper limit of the vinyl equivalent is preferably 1,000 or less, more preferably 700 or less, further preferably 500 or less.

The polyvalent hydroxy resin that is the raw material of the polyfunctional vinyl resin (1) of the present invention is represented by the following general formula (4).

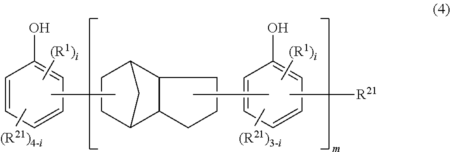

In the general formula (4), R¹ and i have the same meanings as the respective definitions in the general formula (1). m has the same meaning as n in the general formula (1), and almost the same applies to the relationship between a raw material and a product. Each R²¹ independently represents a hydrogen atom, or a group represented by the following formula (5) or the following formula (6), and at least one is the formula (5) or the formula (6). Each R²¹ also does not necessarily represent only a substituent, and also represents a hydrogen atom as in R² in the general formula (1).

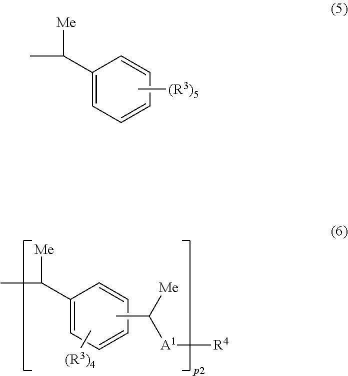

In the formula (5), R³ has the same meaning as the definition in the formula (2).

In the formula (6), each of R³, R⁴, and Me have the same meanings as the respective definitions in the formula (3). p2 has the same meaning as p1 in the formula (3), and almost the same applies to the relationship between a raw material and a product. A¹ represents a residue obtained by removing two R²¹ from the formula (4) and each R²¹ in the residue represents a hydrogen atom or a group represented by the formula (5). In other words, A¹ is a divalent group having a structure similar to the general formula (4), but is not a group represented by the formula (6).

The polyvalent hydroxy resin represented by the general formula (4) preferably has a weight average molecular weight (Mw) of 400 to 5,000, more preferably 500 to 3,000, further preferably 600 to 2,500. The polyvalent hydroxy resin preferably has a number average molecular weight (Mn) of 350 to 2,000, more preferably 400 to 1,500, further preferably 450 to 1,000.

The phenolic hydroxyl group equivalent (g/eq.) is preferably 190 to 500, more preferably 220 to 400, further preferably 250 to 350.

The softening point is preferably 50 to 180° C., more preferably 50 to 120° C.

The polyvalent hydroxy resin (4) represented by the general formula (4) is obtained by subjecting a dicyclopentadiene-type polyvalent hydroxy resin (a) represented by the following general formula (7) and an aromatic monovinyl compound represented by the general formula (8a) and/or an aromatic divinyl compound represented by the general formula (8b) to an electrophilic aromatic substitution reaction in the presence of an acid catalyst. Aromatic monovinyl compounds and aromatic divinyl compounds are collectively referred to as the aromatic vinyl compound. The aromatic vinyl compounds (8a) and (8b) have no halogenated methyl group, unlike a halogenated methyl group-containing aromatic vinyl compound (10).

Herein, the polyvalent hydroxy resin (a) represented by the general formula (7) has a structure where a phenol compound is linked by dicyclopentadiene.

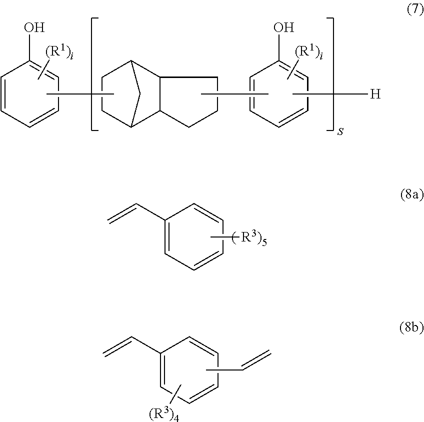

In the general formula (7), R¹ and i have the same meanings as the respective definitions in the general formula (1), s has the same meaning as n in the general formula (1), and almost the same applies to the relationship between a raw material and a product.

In the general formulas (8a) and (8b), R³ has the same meaning as the definition in the formula (2). When R³ is a substituent, the position of substitution may be any of the ortho-position, the meta-position, and the para-position with respect to a vinyl group, and is preferably the meta-position or the para-position.

In the aromatic divinyl compound represented by the general formula (8b), the position of substitution of a vinyl group with respect to another vinyl group may be any of the ortho-position, the meta-position, and the para-position, is preferably the meta-position or the para-position, or may be a combination thereof.

The aromatic vinyl compound used as the raw material essentially contains the aromatic monovinyl compound (8a) and the aromatic divinyl compound (8b). As the amount of compounding of the aromatic divinyl compound is larger, the molecular weight of the polyvalent hydroxy resin (4) is increased. Thus, the amount of compounding may be adjusted in consideration of the molecular weight of the polyvalent hydroxy resin (4) in order that an objective molecular weight is achieved. The aromatic monovinyl compound is the substituent represented by the formula (2) due to addition reaction, and exerts a greater effect of reducing dielectric properties.

Examples of the aromatic monovinyl compound (8a) include vinyl aromatic compounds such as styrene, vinylnaphthalene, vinyl biphenyl, and α-methylstyrene; nuclear alkyl-substituted vinyl aromatic compounds such as o-methylstyrene, m-methylstyrene, p-methylstyrene, o,p-dimethylstyrene, o-ethylvinylbenzene, m-ethylvinylbenzene, p-ethylvinylbenzene, ethyl vinyl biphenyl, and ethylvinylnaphthalene; and cyclic vinyl aromatic compounds such as indene, acenaphthylene, benzothiophene, and coumarone. Preferred are styrene and ethylvinylbenzene.

These can be used singly or in combinations of two or more kinds thereof.

Examples of the aromatic divinyl compound (8b) include divinyl aromatic compounds such as divinylbenzene, divinylnaphthalene, and divinyl biphenyl. Preferred is divinylbenzene. These can be used singly or in combinations of two or more kinds thereof.

The amounts of compounding of the aromatic monovinyl compound (8a) and the aromatic divinyl compound (8b) may be respectively 15 to 50% by mass and 50 to 85% by mass based on the entire amount of the aromatic vinyl compound. The amount of compounding of the aromatic monovinyl compound (8a) is preferably 15 to 50% by mass, more preferably 17 to 45% by mass. The amount of compounding of the aromatic divinyl compound (8b) is preferably 50 to 85% by mass, more preferably 55 to 83% by mass.

The phenolic hydroxyl group equivalent (g/eq.) in the polyvalent hydroxy resin (a) represented by the general formula (7) is preferably 160 to 220, more preferably 165 to 210, further preferably 170 to 200.

The contents of an s=0 form, an s=1 form, and an s≥2 form, according to GPC, are preferably respectively in the ranges of 10% by area or less, 50 to 90% by area, and 0 to 50% by area.

The polyvalent hydroxy resin (a) represented by the general formula (7) is obtained by reacting a phenol compound represented by the following general formula (9) with dicyclopentadiene in the presence of a Lewis acid. In this reaction, not only an isomer having a different substitution position, but also a structure where a dicyclopentadiene structure and the hydroxyl group of phenol are bonded may be included.

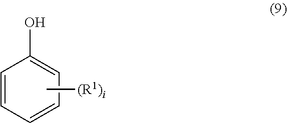

In the general formula (9), R¹ and i have the same meanings as the respective definitions in the general formula (1). The position of substitution with R¹ may be any of the ortho-position, the meta-position, and the para-position, and is preferably the ortho-position.

The structure of dicyclopentadiene is as follows.

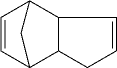

Examples of the phenol compound represented by the general formula (9) include phenol, cresol, ethylphenol, propylphenol, isopropylphenol, n-butylphenol, t-butylphenol, hexylphenol, cyclohexylphenol, phenylphenol, tolylphenol, benzylphenol, α-methylbenzylphenol, allylphenol, dimethylphenol, diethylphenol, dipropylphenol, diisopropylphenol, di(n-butyl)phenol, di(t-butyl)phenol, dihexylphenol, dicyclohexylphenol, diphenylphenol, ditolylphenol, dibenzylphenol, bis(α-methylbenzyl)phenol, methylethylphenol, methylpropylphenol, methylisopropylphenol, methylbutylphenol, methyl-t-butylphenol, methyl allylphenol and tolylphenylphenol. Phenol, cresol, phenylphenol, dimethylphenol, or diphenylphenol is preferable, and cresol and dimethylphenol are particularly preferable, from the viewpoints of availability, and reactivity of a cured product obtained.

The catalyst for use in the reaction is a Lewis acid, is specifically, for example, boron trifluoride, a boron trifluoride/phenol complex, a boron trifluoride/ether complex, aluminum chloride, tin chloride, zinc chloride or iron chloride, and in particular, a boron trifluoride/ether complex is preferable in terms of ease of handling. In the case of a boron trifluoride/ether complex, the amount of the catalyst used is 0.001 to 20 parts by mass, preferably 0.5 to 15 parts by mass based on 100 parts by mass of the dicyclopentadiene.

The amount of the dicyclopentadiene used per mol of the phenol compound, is 0.08 to 0.80 mol, preferably 0.09 to 0.60 mol, more preferably 0.10 to 0.50 mol, further preferably 0.10 to 0.40 mol, particularly preferably 0.10 to 0.20 mol.

The reaction is favorably made in a manner where the phenol compound and a catalyst are loaded into a reactor and dicyclopentadiene is dropped over 0.1 to 10 hours, preferably 0.5 to 8 hours, more preferably 1 to 6 hours.

The reaction temperature is preferably 50 to 200° C., more preferably 100 to 180° C., further preferably 120 to 160° C. The reaction time is preferably 1 to 10 hours, more preferably 3 to 10 hours, further preferably 4 to 8 hours.

After completion of the reaction, the catalyst is deactivated by addition of an alkali such as sodium hydroxide, potassium hydroxide, or calcium hydroxide. Thereafter, a solvent, for example, an aromatic hydrocarbon compound such as toluene or xylene or a ketone compound such as methyl ethyl ketone or methyl isobutyl ketone is added for dissolution, the resultant is washed with water, thereafter the solvent is recovered under reduced pressure, and thus the objective polyvalent hydroxy resin represented by the general formula (7) can be obtained. Preferably, the dicyclopentadiene is reacted in the entire amount as much as possible and the unreacted raw material phenol compound is recovered under reduced pressure.

During the reaction, a solvent, for example, an aromatic hydrocarbon compound such as benzene, toluene or xylene, a ketone compound such as methyl ethyl ketone or methyl isobutyl ketone, a halogenated hydrocarbon compound such as chlorobenzene or dichlorobenzene, or an ether compound such as ethylene glycol dimethyl ether or diethylene glycol dimethyl ether may be, if necessary, used.

The reaction method for introducing the aromatic backbone structure of the formula (5) or formula (6) into the benzene ring of the polyvalent hydroxy resin (a) represented by the general formula (7) is a method for reacting the aromatic vinyl compounds (8a) and (8b) with the polyvalent hydroxy resin (a) at a predetermined ratio. The reaction ratio of the aromatic vinyl compound per mol of the phenolic hydroxyl group of the polyvalent hydroxy resin (a) is 0.05 to 2.0 mol, more preferably 0.1 to 1.0 mol, particularly preferably 0.15 to 0.95 mol.

Herein, the reaction is the electrophilic aromatic substitution reaction, and the reaction object is just a benzene ring. However, as is clear from the structure, one OH group corresponds to one benzene ring, and the electrophilic aromatic substitution reaction (Friedel Crafts-type reaction) generally rapidly progresses when having a phenol backbone. Therefore, the phenolic hydroxyl group was used as the reference.

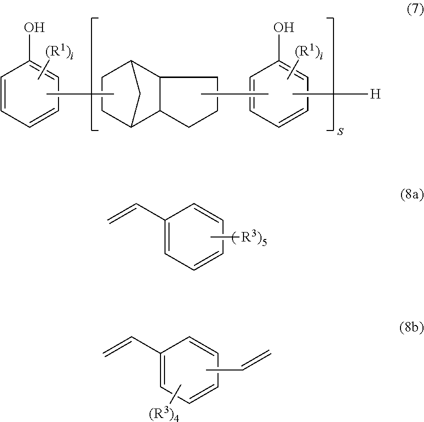

The catalyst for use in the reaction is an acid catalyst, and specific examples thereof include mineral acids such as hydrochloric acid, sulfuric acid, and phosphoric acid, organic acids such as formic acid, oxalic acid, trifluoroacetic acid, and p-toluenesulfonic acid, Lewis acids such as zinc chloride, aluminum chloride, iron chloride, and boron trifluoride, and solid acids such as activated white earth, silica-alumina, and zeolite. In particular, p-toluenesulfonic acid is preferable in terms of ease of handling. In the case of p-toluenesulfonic acid, the amount of the catalyst used is 0.001 to 20 parts by mass, preferably 0.5 to 10 parts by mass based on 100 parts by mass of the polyvalent hydroxy resin (a).

The reaction is favorably made in a manner where the polyvalent hydroxy resin (a), the catalyst and a solvent are loaded into a reactor and dissolved, and then the aromatic vinyl compound is dropped over 0.1 to 10 hours, preferably 0.5 to 8 hours, more preferably 0.5 to 5 hours.

The reaction temperature is preferably 50 to 200° C., more preferably 100 to 180° C., further preferably 120 to 160° C. The reaction time is preferably 1 to 10 hours, more preferably 3 to 10 hours, further preferably 4 to 8 hours.

After completion of the reaction, the catalyst is deactivated by addition of an alkali such as sodium hydroxide, potassium hydroxide, or calcium hydroxide. Thereafter, a solvent, for example, an aromatic hydrocarbon compound such as toluene or xylene or a ketone compound such as methyl ethyl ketone or methyl isobutyl ketone is added for dissolution, the resultant is washed with water, thereafter the solvent is recovered under reduced pressure, and thus an objective polyvalent hydroxy resin can be obtained.

Examples of the solvent used in the reaction include solvents, for example, aromatic hydrocarbon compounds such as benzene, toluene and xylene, ketone compounds such as methyl ethyl ketone and methyl isobutyl ketone, halogenated hydrocarbon compounds such as chlorobenzene and dichlorobenzene, and ether compounds such as ethylene glycol dimethyl ether and diethylene glycol dimethyl ether. Such solvents may be used singly or as a mixture of two or more kinds thereof.

The polyvalent hydroxy compound (resin) represented by the general formula (4) used is preferably a polyvalent hydroxy resin obtained through the above reaction, but is not limited thereto.

As the method for obtaining the polyfunctional vinyl resin of the general formula (1), an etherification method is excellent. Examples thereof include a method for reacting the polyvalent hydroxy resin (4) represented by the general formula (4) with the halogenated methyl group-containing aromatic vinyl compound represented by the general formula (10) in a solvent, in the presence of an alkali compound. The etherification reaction herein refers to a bimolecular nucleophilic substitution reaction between a phenolic hydroxyl group of the polyvalent hydroxy resin and a halogenated methyl group of the halogenated methyl group-containing aromatic vinyl compound. In this case, the reaction is favorably made in a manner where the polyvalent hydroxy resin (4) and a solvent are loaded into a reactor and dissolved, and then a halogenated methyl group-containing aromatic vinyl compound (10) solution and an alkali compound are added thereto.

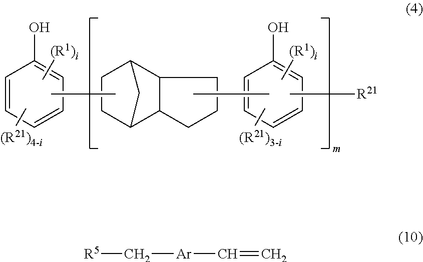

In the general formula (10), Ar has the same meaning as the definition in the formula (1a), R⁵ represents a halogen and is preferably a chlorine atom or a bromine atom.

As for the use ratio of the polyvalent hydroxy resin to the halogenated methyl group-containing aromatic vinyl compound, the reaction is made so that the halogenated methyl group of the halogenated methyl group-containing aromatic vinyl compound can be preferably 0.5 to 1.5 equivalents, more preferably 0.8 to 1.2 equivalents per equivalent of the phenolic hydroxyl group of the polyvalent hydroxy resin.

The halogenated methyl group-containing aromatic vinyl compound is preferably halomethylstyrene. Specific examples of halomethylstyrene include chloromethylstyrene, bromomethylstyrene, isomers thereof, and those having a substituent. For example, in the case of halomethylstyrene, the substitution position of the halomethyl compound is preferably the 3-position or the 4-position, and each content is preferably in the range of 1/99 to 99/1. Examples of the commercial product of chloromethylstyrene include CMS-P (manufactured by AGC SEIMI CHEMICAL CO., LTD., 3-position/4-position=50/50) and CMS-14 (manufactured by AGC SEIMI CHEMICAL CO., LTD., 3-position/4-position=5/95).

The alkali compound used for the production of the polyfunctional vinyl resin of the present invention is preferably an alkali metal hydroxide, a carbonate, or the like. Specific examples thereof include sodium hydroxide, potassium hydroxide, potassium carbonate, and sodium carbonate, and sodium hydroxide or potassium hydroxide is preferable. Such alkali metal hydroxides may be used in a solid state or in a solution state.

The amount of the alkali compound used is usually 1.0 to 2.0 mol, preferably 1.0 to 1.8 mol, more preferably 1.0 to 1.5 mol, further preferably 1.0 to 1.3 mol, particularly preferably 1.0 to 1.1 mol per mol of a phenolic hydroxyl group of the polyvalent hydroxy resin.

The solvent used in the production of the polyfunctional vinyl resin of the present invention is not particularly limited, and examples thereof include alcohols such as methanol, ethanol, n-propanol, isopropanol, and n-butanol; ketones such as acetone, methyl ethyl ketone, and methyl isobutyl ketone; ethers such as tetrahydrofuran, dioxane, and diglyme; and aprotic polar solvents such as dimethylacetamide, dimethylformamide, and dimethylsulfoxide. One or two or more solvents can be used from these compounds. In addition, water may be used by mixing with a solvent. In addition to water and the solvents described above, solvents such as toluene (other organic solvents) may be contained, and the amount of other organic solvents used is in the range of 0.5 to 400% by mass, preferably in the range of 100 to 300% by mass, more preferably in the range of 150 to 250% by mass based on the amount of the above-described solvent used.

The amount of the solvent used is preferably 20 to 500% by mass, more preferably 25 to 400% by mass, particularly preferably 25 to 350% by mass, based on the total mass of the polyvalent hydroxy resin. In particular, since the aprotic polar solvent is not useful for purification such as washing with water, has a high boiling point, and is difficult to be removed, it is not preferable that the amount thereof used be more than 500% by mass based on the total mass of the polyvalent hydroxy resin.

The reaction temperature in the production of the polyfunctional vinyl resin of the present invention is usually 30 to 90° C., preferably 35 to 80° C. To obtain a polyfunctional vinyl resin having a higher purity, the reaction temperature is preferably raised in two stages or more, and for example, it is particularly preferable to set the first stage to 15 to 50° C. and the second stage to 45 to 70° C.

The reaction time in the production of the polyfunctional vinyl resin of the present invention is usually 0.5 to 10 hours, preferably 1 to 8 hours, particularly preferably 1 to 5 hours. When the reaction time is 0.5 hours or more, the reaction sufficiently proceeds, and when it is 10 hours or less, the amount of the by-product produced can be suppressed.

After completion of the reaction, the solvent is distilled off under heating and reduced pressure and then dissolved in a solvent such as a ketone solvent having 4 to 7 carbon atoms (e.g., methyl isobutyl ketone, methyl ethyl ketone, cyclopentanone, or cyclohexanone) or a solvent such as toluene, or directly dissolved therein without being distilled off. The mixed solvent is washed with water in a state warmed at 40 to 90° C., more preferably 50 to 80° C. until the aqueous layer has a pH of 5 to 8, and the salt as a by-product is removed. Upon washing with water, an alcohol such as methanol, ethanol, or propanol may be added.

The polyfunctional vinyl resin of the present invention is usually produced while blowing inert gas such as nitrogen into the system (into air or liquid). By performing the reaction while blowing inert gas into the system, the product to be obtained can be prevented from being colored.

The amount of inert gas blown per unit hour varies depending on the volume of a vessel to be used in the reaction. For example, the amount of inert gas blown per unit hour is preferably adjusted so that the volume of the vessel can be replaced for 0.5 to 20 hours.

When self-polymerization of the halogenated methyl group-containing aromatic vinyl compound is concerned, a polymerization inhibitor such as a quinone, a nitro compound, a nitrophenol compound, a nitroso compound, a nitrone compound, a phenol compound, or oxygen may be used.

The end point of the reaction can be determined by following the amount of the halogenated methyl group-containing aromatic vinyl compound remained by various chromatograms, and can be adjusted by adjusting the kind and amount of metal hydroxide, adjusting the addition rate, and utilizing an appropriate catalyst, as the method for adjusting the reaction rate.

The polyfunctional vinyl resin of the present invention can be cured alone, and is also suitably used as a polyfunctional resin composition in which various additives are compounded. For example, the polyfunctional vinyl resin of the present invention can be cured by compounding a radical polymerization initiator to promote curing.

The resin composition of the present invention is cured by the crosslinking reaction caused by a means such as heating as described below, and for example, a radical polymerization initiator (also referred to as a radical polymerization catalyst) may be contained therein and used as the radical polymerization initiator for the purpose of reducing the reaction temperature during curing or promoting the crosslinking reaction of the unsaturated group. The amount of the radical polymerization initiator to be used for this purpose is preferably 0.01 to 12 parts by mass, more preferably 0.1 to 8 parts by mass based on 100 parts by mass of the polyfunctional vinyl resin.

Specific examples of the radical polymerization initiator include peroxides such as benzoyl peroxide, cumene hydroperoxide, 2,5-dimethylhexane-2,5-dihydroperoxide, 2,5-dimethyl-2,5-di(t-butylperoxy)hexine-3, di-t-butyl peroxide, t-butylcumyl peroxide, α,α′-bis(t-butylperoxy-m-isopropyl)benzene, 2,5-dimethyl-2,5-di(t-butylperoxy)hexane, dicumyl peroxide, di-t-butyl peroxyisophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl) peroxide, and trimethylsilyl triphenylsilyl peroxide, but not limited thereto. Although it is not a peroxide, 2,3-dimethyl-2,3-diphenylbutane can also be used as the radical polymerization initiator (or the polymerization catalyst). However, the catalyst and radical polymerization initiator used in curing of the present resin composition are not limited to these examples.

The polyfunctional vinyl resin composition of the present invention can be used with other resin components, as long as the effect of the polyfunctional vinyl resin represented by the formula (1) as an essential component is not inhibited. The polyfunctional vinyl resin composition of the present invention is preferably compounded in an amount of 50% by mass or less based on the total amount of the resin component.

As other resin components, vinyl resins or other thermal polyfunctional vinyl resins can be compounded. Examples thereof include a vinyl ester resin, a polyvinyl benzyl resin, an epoxy resin, an oxetane resin, a maleimide resin, an acrylate resin, a polyester resin, a polyurethane resin, a polycyanato resin, a phenol resin, and a benzoxazine resin.

In addition, thermoplastic resins such as a polystyrene resin, a polyphenylene ether resin, a polyetherimide resin, a polyethersulfone resin, a PPS resin, a polycyclopentadiene resin, and a polycycloolefin resin; thermoplastic elastomers such as a styrene-ethylene-propylene copolymer, a styrene-ethylene-butylene copolymer, a styrene-butadiene copolymer, a styrene-isoprene copolymer, a hydrogenated styrene-butadiene copolymer, and a hydrogenated styrene-isoprene copolymer; and rubbers such as polybutadiene and polyisoprene can also be compounded.

Various known flame retardants can be each used in the polyfunctional vinyl resin composition of the present invention, for the purpose of an enhancement in flame retardance of a cured product obtained, within a range of not reducing reliability. Examples of such a usable flame retardant include a halogen-based flame retardant, a phosphorus-based flame retardant, a nitrogen-based flame retardant, a silicone-based flame retardant, an inorganic flame retardant and an organic metal salt-based flame retardant. A halogen-free flame retardant is preferable and a phosphorus-based flame retardant is particularly preferable, from the viewpoint of the environment. Such flame retardants may be used singly, those of the same system may be used in combinations of two or more kinds, or those of different systems may be used in combinations.

In the polyfunctional vinyl resin composition of the present invention, components other than those mentioned above (in the present invention, sometimes referred to as “other components”) may be contained for the purpose of further enhancement in its functionality. Examples of such other components include a filler, an ultraviolet protection agent, an antioxidant, a coupling agent, a plasticizer, a flux, thixotropy imparting agent, a lubricating agent, a colorant, a pigment, a dispersing agent, an emulsifier, a low viscoelasticity imparting agent, a release agent, a defoamer, and an ion trapping agent.

Examples of the filler include inorganic fillers such as fused silica, crystalline silica, alumina, silicon nitride, boron nitride, aluminum nitride, aluminum hydroxide, calcium hydroxide, magnesium hydroxide, boehmite, talc, mica, clay, calcium carbonate, magnesium carbonate, barium carbonate, zinc oxide, titanium oxide, magnesium oxide, magnesium silicate, calcium silicate, zirconium silicate, barium sulfate, and carbon; fibrous fillers such as carbon fiber, glass fiber, alumina fiber, silica alumina fiber, silicon carbide fiber, polyester fiber, polyamide fiber, cellulose fiber, aramid fiber, and ceramic fiber; and fine particle rubber.

Examples of other components include quinacridone-based, azo-based, and phthalocyanine-based organic pigments; inorganic pigments such as titanium oxide, a metal foil pigment, and an anticorrosive pigment; hindered amine-based, benzotriazole-based, and benzophenone-based ultraviolet absorbers; hindered phenol-based, phosphorus-based, sulfur-based, and hydrazide-based antioxidants; release agents such as stearic acid, palmitic acid, zinc stearate, and calcium stearate; and additives such as a leveling agent, a rheology controlling agent, a pigment dispersing agent, a cissing inhibitor, and a defoamer. The amount of these other components compounded is preferably in the range of 0.01 to 20% by mass based on the solid content in the resin composition.

The polyfunctional vinyl resin composition of the present invention can be dissolved in a solvent, to thereby produce a resin varnish. Examples of the solvent include methyl ethyl ketone, acetone, toluene, xylene, tetrahydrofuran, dioxolane, dimethylformamide, methyl isobutyl ketone, methoxy propanol, cyclohexanone, methyl cellosolve, ethyl diglycol acetate, propylene glycol monomethyl ether acetate, and γ-butyrolactone, and the selection and proper amount of use thereof can be appropriately selected depending on applications. For example, a solvent having a boiling point of 160° C. or less, such as methyl ethyl ketone, acetone, toluene, xylene, or 1-methoxy-2-propanol is preferable in printed wiring board applications, and the solvent is preferably used in a proportion such that the non-volatile content can be 20 to 80% by mass. On the other hand, in build-up adhesion film applications, for example, ketones such as acetone, methyl ethyl ketone, and cyclohexanone; ester compounds such as ethyl acetate, butyl acetate, cellosolve acetate, propylene glycol monomethyl ether acetate, carbitol acetate, and γ-butyrolactone; carbitols such as cellosolve and butylcarbitol; aromatic hydrocarbons such as toluene and xylene; dimethylformamide, dimethylacetamide, and N-methylpyrrolidone can be preferably used, and are preferably used in a proportion such that the non-volatile content can be 20 to 80% by mass. The laminated board of the present invention can be obtained by curing the resin varnish. Specific examples thereof include a printed-wiring substrate, a printed-circuit board, a flexible printed-wiring board, and a build-up wiring board.

The cured product obtained by curing the polyfunctional vinyl resin composition of the present invention can be used as a shaped product, a laminated product, a cast product, an adhesive, a coating film, and a film. For example, the cured product of a semiconductor sealing material is a cast product or a shaped product. As for the method for obtaining a cured product for this application, the compound is molded using a cast, a transfer molding machine, an injection molding machine, or the like, and further heating the molded product at 80 to 230° C. for 0.5 to 10 hours, to thereby obtain a cured product. In addition, the cured product of the resin varnish is a laminated product. As for the method for obtaining the cured product, base materials such as the above fibrous filler or paper are impregnated with the resin varnish, heated, and dried to obtain prepregs, a single prepreg is laminated with another single one or a metal foil such as a copper foil, and the laminate is subjected to hot press molding, to thereby obtain a cured product. In addition, an uncured sheet or a partially cured sheet of the polyfunctional vinyl resin composition of the present invention can be suitably used as, for example, a build-up film, a bonding sheet, a coverlay sheet, a bump sheet for flip chip bonders, and an insulating layer or adhesion layer for substrates.

In addition, the polyfunctional vinyl resin composition of the present invention is useful as a material for electronic components, in particular, a material for high frequency electronic components by compounding inorganic high dielectric powder such as barium titanate or an inorganic magnetic material such as ferrite.

Then, the prepreg of the present invention and the cured product thereof will be described. To enhance mechanical strength and increase dimension stability, a base material is added to the prepreg of the present invention.

As such a base material, cloths and papers, for example, various glass cloths such as woven roving, cloth, chopped mat, and surfacing mat; asbestos cloth, metal fiber cloth, and other synthetic or natural inorganic fiber cloths; woven fabrics or non-woven fabrics obtained from liquid crystal fibers such as wholly aromatic polyamide fiber, wholly aromatic polyester fiber, and polybenzoxazole fiber; woven fabrics or non-woven fabrics obtained from synthetic fibers such as polyvinyl alcohol fiber, polyester fiber, and acrylic fiber; natural fiber cloths such as cotton cloth, hemp cloth, and felt; and natural cellulose cloths such as carbon fiber cloth, craft paper, cotton paper, and paper-glass mixed paper can be used each singly or in combinations of two or more.

The proportion of the base material may be 5 to 90% by mass, is preferably 10 to 80% by mass, further preferably 20 to 70% by mass in the prepreg. When the base material is less than 5% by mass, the dimension stability and strength of the cured product tend to be reduced. When the proportion of the base material is more than 90% by mass, dielectric properties of the cured product tend to be reduced.

In the prepreg of the present invention, a coupling agent can be used for the purpose of improving adhesiveness at the interface of the resin and the base material, if necessary. As the coupling agent, a common coupling agent such as a silane coupling agent, a titanate coupling agent, an aluminum-based coupling agent, or a zircoaluminate coupling agent can be used.

Examples of the method for producing the prepreg of the present invention include a method in which the polyfunctional vinyl resin composition of the present invention and, if necessary, other components are uniformly dissolved or dispersed in, for example, the above-described aromatic or ketone-based solvent, or a mixed solvent thereof, a base material is impregnated therewith and then dried. Impregnation is performed by immersion (dipping), coating, or the like. Impregnation can be repeated a plurality of times if necessary, and at this time, impregnation can be repeated using a plurality of solutions each having a different composition and concentration, to thereby adjust the resin composition and the amount of resin to finally intended ones.

A cured product can be obtained by curing the prepreg of the present invention by a method such as heating. The production method thereof is not particularly limited, and for example, a plurality of prepregs can be stacked, and layers can be adhered and simultaneously subjected to heat curing under heating and pressurization to obtain a cured product (laminated board) having a desired thickness. It is also possible to combine a cured product adhered and cured once and the prepreg to obtain a multilayer laminate having a novel layer structure. Laminate forming and curing are usually simultaneously performed using a heat press or the like, and each of them may be performed singly. That is, an uncured or semi-cured prepreg obtained by laminate forming in advance can be subjected to heat treatment or treatment by another method to be thereby cured.

Forming and curing can be performed, for example, in the ranges of a temperature: 80 to 300° C., a pressure: 0.1 to 1000 kgf/cm², and a time: 1 minute to 10 hours, more preferably in the ranges of a temperature: 150 to 250° C., a pressure: 1 to 500 kgf/cm², and a time: 1 minute to 5 hours.

The laminate of the present invention is constituted of a layer of the prepreg of the present invention and a metal foil layer. Examples of the metal foil used herein include a copper foil and an aluminum foil. The thickness thereof is not particularly limited, and is in the range of 3 to 200 μm, more preferably 3 to 105 μm.

Examples of the method for producing the laminate of the present invention include a method in which the prepreg obtained from the polyfunctional vinyl resin composition of the present invention and the base material described above and a metal foil are laminated in a layer structure according to purpose, and layers are adhered and simultaneously subjected to heat curing under heating and pressurization. In the laminate of the polyfunctional vinyl resin composition of the present invention, the cured product and the metal foil are laminated in an arbitrary layer structure. The metal foil can be used as both a surface layer and an intermediate layer. In addition, it is possible to form a multilayer by repeating lamination and curing a plurality of times.

In adhesion with the metal foil, an adhesive can be used. Examples of the adhesive include epoxy-based, acrylic, phenolic, and cyanoacrylate-based adhesives, but are not particularly limited thereto. Laminate forming and curing described above can be performed under the same conditions as the production of the cured product of the prepreg of the present invention.

It is also possible to form the polyfunctional vinyl resin composition of the present invention into a film. The thickness thereof is not particularly limited, and is in the range of 3 to 200 μm, more preferably 5 to 105 μm.

Examples of the method for producing the film of the present invention include, but are not particularly limited to, a method in which the polyfunctional vinyl resin composition and, if necessary, other components are uniformly dissolved or dispersed in, for example, an aromatic or a ketone-based solvent, or a mixed solvent thereof, and a resin film such as a PET film is coated therewith and then dried. Coating can be repeated a plurality of times if necessary, and at this time, coating can be repeated using a plurality of solutions each having a different composition and concentration, to thereby adjust the resin composition and the amount of resin to finally desired ones.

When the resin sheet of the present invention is used as a bonding sheet, for example, two base materials can be adhered with the resin sheet. Each of two base materials is, for example, a laminated board or a printed wiring board. Specifically, for example, the polyfunctional vinyl resin composition is formed into a sheet on a support film by a coating method or the like and then heated for drying or semi-curing to produce a resin sheet. This resin sheet is stacked on a base material (the first base material), the support film is peeled from the resin sheet, and another base material (the second base material) is stacked thereon. That is, the first base material, the resin sheet (the polyfunctional vinyl resin composition), and the second base material are laminated in the order presented. Subsequently, the first base material and the second base material are adhered via the cured product of the polyfunctional vinyl resin composition by heating and curing.

It is also possible to obtain a metal foil with resin from the polyfunctional vinyl resin composition of the present invention and a metal foil. Examples of the metal foil used herein include a copper foil and an aluminum foil. The thickness thereof is not particularly limited, and is in the range of 3 to 200 μm, more preferably 5 to 105 μm.

Examples of the method for producing the metal foil with resin include, but are not particularly limited to, a method in which the polyfunctional vinyl resin composition and, if necessary, other components are uniformly dissolved or dispersed in, for example, an aromatic or a ketone-based solvent, or a mixed solvent thereof, and a metal film is coated therewith and then dried. Coating can be repeated a plurality of times if necessary, and at this time, coating can be repeated using a plurality of solutions each having a different composition and concentration, to thereby adjust the resin composition and the amount of resin to finally desired ones.

A substrate for electronic materials is formed using the laminate of the present invention. The substrate for electronic materials can be suitably used as a component for various electrical and electronic devices, such as mobile phones, PHS, laptops, personal digital assistant (PDA), portable video telephone sets, personal computers, super computers, servers, routers, liquid-crystal projectors, engineering work station (EWS), pagers, word processors, televisions, viewfinder-type or monitor-direct-view-type video tape recorders, electronic notebooks, electronic desk calculators, car navigation equipment, POS terminals, and apparatuses equipped with a touch panel, which are demanded to have reliability in an environment requiring heat resistance and water resistance, and transmission reliability of high frequency signals. In particular, the substrate for electronic materials can be suitably used as a circuit substrate for electrical and electronic devices described above due to excellent dielectric properties, heat resistance stability, dimension stability corresponding to the formation of a circuit with fine pattern, and moldability of the cured product of the present invention. Specific examples thereof include one-side substrates, double-side substrates, multilayer printed substrates, flexible substrates, and build-up substrate. A multilayer circuit board using metal plating for the conductor layer is also included in preferred examples.

### EXAMPLES

The present invention is specifically described with reference to Examples and Comparative Examples, but the present invention is not limited thereto. Unless particularly noted, “parts” represents “parts by mass”, “%” represents “% by mass”, and “ppm” represents “ppm by mass”. Measurement methods were respectively the following measurement methods.

The test conditions of polyvalent hydroxy resins, polyfunctional vinyl resins, and cured products will be shown.

### (1) Hydroxyl Equivalent:

measured in accordance with JIS K 0070 standard, where the unit was expressed by “g/eq.”. Unless particularly noted, the hydroxyl equivalent of a polyvalent hydroxy resin means the phenolic hydroxyl equivalent.

### (2) Softening Point:

measured in accordance with a ring-and-ball method in JIS K 7234 standard. Specifically, an automatic softening point apparatus (ASP-MG4 manufactured by Meitech Company, Ltd.) was used.

### (3) Vinyl Equivalent:

measured in accordance with JIS K 0070 standard. Specifically, a sample was allowed to react with a Wijs solution (iodine monochloride solution), allowed to stand in a dark place, and thereafter, excess iodine chloride was reduced to iodine, and an iodine content was titrated with sodium thiosulfate to calculate the iodine value. The iodine value was converted to the vinyl equivalent.

### (4) Total Chlorine:

measured in accordance with JIS K 7243-3 standard. Specifically, measurement was made as follows: 1.0 g of a sample was dissolved in 25 mL of butyl carbitol, 25 mL of a 1 N-KOH propylene glycol solution was then added, the mixture was heated under reflux for 10 minutes and then cooled to room temperature, 100 mL of a 80% aqueous acetone solution was added, and the mixture was subjected to potentiometric titration with an aqueous 0.002 N—AgNO₃ solution.

### (5) Relative Permittivity and Dielectric Tangent:

measured in accordance with IPC-TM-650 2.5.5.9. Specifically, evaluation was made by determining the relative permittivity and the dielectric tangent at a frequency of 1 GHz by a capacitance method by use of a material analyzer (manufactured by AGILENT Technologies).

### (6) Copper Foil Peel Strength:

measured in accordance with JIS C6481 standard.

### (7) Glass Transition Temperature (Tg):

measured in accordance with JIS C6481 standard. Specifically, the glass transition temperature was expressed by the tan δ peak top when measurement was made using a dynamic mechanical analyzer (EXSTAR DMS6100 manufactured by Hitachi High-Technologies Corporation) under temperature rising conditions of 5° C./minute.

### (8) GPC (Gel Permeation Chromatography) Measurement:

columns (TSKgelG4000H_{XL}, TSKgelG3000H_{XL} and TSKgelG2000H_{XL} manufactured by Tosoh Corporation) connected to the main body (HLC-8220 GPC manufactured by Tosoh Corporation) in series were used, and the column temperature was 40° C. The eluent here used was tetrahydrofuran (THF) at a flow rate of 1 mL/min, and the detector here used was a differential refractive index detector. The measurement specimen here used was 50 μL of one obtained by dissolving 0.1 g of a sample in 10 mL of THE and filtering the solution by a micro filter. Mw and Mn were determined by conversion from the calibration curve determined using standard polystyrene (PStQuick Kit-H manufactured by Tosoh Corporation). GPC-8020 Model II version 6.00 manufactured by Tosoh Corporation was used for data processing.

### (9) IR:

using Fourier transform infrared spectroscopy (Spectrum One FT-IR Spectrometer 1760X manufactured by Perkin Elmer Precisely) and diamond ATR, ATR was coated with a sample dissolved in toluene and dried, and thereafter, absorbance at wavenumbers from 650 to 4000 cm⁻¹ was measured.

Abbreviations used in Examples and Comparative Examples are as follows.

### [Polyvalent Hydroxy Resin]

PH1: Polyvalent hydroxy resin obtained in Synthesis Example 1
P1: Polyvalent hydroxy resin obtained in Synthesis Example 2
P2: Polyvalent hydroxy resin obtained in Synthesis Example 3
P3: Biphenyl aralkyl-type polyvalent hydroxy resin (MEH-7851 manufactured by Meiwa Plastic Industries, Ltd., phenol hydroxyl group equivalent 223) P4: Phenol novolac resin (BRG-555 manufactured by Aica Kogyo Co., Ltd., phenol hydroxyl group equivalent 105)

### [Polyfunctional Vinyl Resin]

V1: Polyfunctional vinyl resin obtained in Example 1
V2: Polyfunctional vinyl resin obtained in Example 2
V3: Polyfunctional vinyl resin obtained in Example 3
VH1: Polyfunctional vinyl resin obtained in Comparative Example 1
VH2: Polyfunctional vinyl resin obtained in Comparative Example 2
VH3: Polyfunctional vinyl resin obtained in Comparative Example 3
VH4: Polyfunctional vinyl resin (OPE-2ST manufactured by Mitsubishi Gas Chemical Company, Inc., Mn 1187, vinyl group equivalent 590)
PO: Organic peroxide (perbutyl P manufactured by NOF CORPORATION)
AO: Antioxidant (ADK STAB AO-60 manufactured by ADEKA Corporation)

### Synthesis Example 1

A reaction apparatus including a separable flask made of glass, equipped with a stirrer, a thermometer, a nitrogen blowing tube, a dropping funnel and a cooling tube was loaded with 500 parts of 2,6-xylenol (the following structural formula):

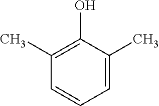

and 7.3 parts of a 47% BF₃ ether complex, and the resulting mixture was warmed to 100° C. with stirring. While this temperature was kept, 67.6 parts of dicyclopentadiene (the following structural formula):

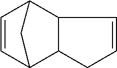

(0.12-fold moles relative to 2,6-xylenol) was dropped for 1 hour. Furthermore, the reaction was made at a temperature of 115 to 125° C. for 4 hours, and 11 parts of calcium hydroxide was added. Furthermore, 19 parts of an aqueous 10% oxalic acid solution was added. Thereafter, the resultant was warmed to 160° C. for dehydration, and thereafter warmed to 200° C. under a reduced pressure of 5 mmHg, to thereby evaporate and remove the unreacted raw material. A product was dissolved by addition of 1320 parts of methyl isobutyl ketone (MIBK), and washed with water by addition of 400 parts of warm water at 80° C., and an aqueous layer as the lower layer was separated and removed. Thereafter, MIBK was evaporated and removed by warming to 160° C. under a reduced pressure of 5 mmHg, and thus 164 parts of red-brown polyvalent hydroxy resin (PH1) was obtained.

The hydroxyl group equivalent of the polyvalent hydroxy resin (PH1) obtained was 195, and the softening point thereof was 73° C. It was the polyvalent hydroxy resin represented by the formula (7) wherein R¹ was a methyl group and i was 2. In GPC, the Mw was 470, the Mn was 440, the content of an s=0 form was 2.8% by area, the content of an s=1 form was 86.2% by area, and the content of an s≥2 form was 11.0% by area.

### Synthesis Example 2

The same reaction apparatus as in Synthesis Example 1 was loaded with 400 parts of the polyvalent hydroxy resin (PH1) obtained in Synthesis Example 1, 4.0 parts of para-toluenesulfonic acid monohydrate, and 100 parts of MIBK, and the resulting mixture was warmed to 120° C. with stirring. While this temperature was kept, 240 parts of divinylbenzene (manufactured by Sigma-Aldrich, divinylbenzene 80%, ethylvinylbenzene 20%) (the following structural formula):

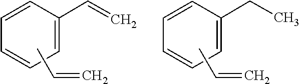

(0.90-fold moles relative to PH1) was dropped for 1 hour. Furthermore, the reaction was made at a temperature of 120 to 130° C. for 4 hours. A product was dissolved by addition of 1400 parts of MIBK, neutralized with 5.3 parts of sodium hydrogen carbonate, and washed with water by addition of 450 parts of warm water at 80° C., and an aqueous layer as the lower layer was separated and removed. Thereafter, MIBK was evaporated and removed by warming to 180° C. under a reduced pressure of 5 mmHg, and thus 608 parts of red-brown polyvalent hydroxy resin (P1) was obtained.

The hydroxyl group equivalent of the polyvalent hydroxy resin (P1) obtained was 302, and the softening point thereof was 82° C. It was the polyvalent hydroxy resin represented by the formula (4) wherein R¹ is a methyl group and i is 2. In GPC, the Mw was 2,000, the Mn was 670, the content of an m=0 form was 3.6% by area, the content of an m=1 form was 41.1% by area, and the content of an m≥2 form was 55.3% by area. In the formula (4), as for R²¹, the group represented by the formula (5) derived from ethylvinylbenzene (one of R³ is an ethyl group) and the group represented by the formula (6) derived from divinylbenzene (all R³ are hydrogen atoms) coexist in a ratio almost the same as the mixing ratio of divinylbenzene as the raw material (20/80).

### Synthesis Example 3

The same reaction apparatus as in Synthesis Example 1 was loaded with 100 parts of polyvalent hydroxy resin (PH1) obtained in Synthesis Example 1, 1.0 part of para-toluenesulfonic acid-monohydrate, and 25 parts of MIBK, and the resulting mixture was warmed to 120° C. with stirring. While this temperature was kept, 45 parts of divinylbenzene (manufactured by Sigma-Aldrich Co. LLC, divinylbenzene 55%, ethylvinylbenzene 45%) (0.67-fold moles relative to PH1) was dropped for 1 hour. Furthermore, the reaction was made at a temperature of 120 to 130° C. for 4 hours. A product was dissolved by addition of 310 parts of MIBK, neutralized with 1.3 parts of sodium hydrogen carbonate, and washed with water by addition of 100 parts of warm water at 80° C., and an aqueous layer as the lower layer was separated and removed. Thereafter, MIBK was evaporated and removed by warming to 180° C. under a reduced pressure of 5 mmHg, and thus 139 parts of red-brown polyvalent hydroxy resin (P2) was obtained.

The hydroxyl group equivalent of the polyvalent hydroxy resin (P2) obtained was 276, and the softening point thereof was 71° C. It was the polyvalent hydroxy resin represented by the formula (4) wherein R¹ is a methyl group and i is 2. In GPC, the Mw was 740, the Mn was 540, the content of an m=0 form was 4.8% by area, the content of an m=1 form was 51.8% by area, and the content of an m≥2 form was 43.4% by area. In the formula (4), as for R²¹, the group represented by the formula (5) derived from ethylvinylbenzene (one of R³ is an ethyl group) and the group represented by the formula (6) derived from divinylbenzene (all R³ are hydrogen atoms) coexist in a ratio almost the same as the mixing ratio of divinylbenzene as the raw material (45/55).

### Example 1

The same apparatus as in Synthesis Example 1 was loaded with 100 parts of the polyvalent hydroxy resin (P1) obtained in Synthesis Example 2, 200 parts of toluene, 100 parts of dimethylsulfoxide, and 25 parts of methanol, and the temperature of the resulting mixture was raised to 60° C. for dissolution. 23.7 parts of 86% potassium hydroxide was added, and the mixture was further allowed to react at 60° C. for 1 hour. After the resulting mixture was cooled to 20° C., 57 parts of chloromethylstyrene (CMS-P manufactured by AGC SEIMI CHEMICAL CO., LTD., 3-position/4-position=50/50; the following structural formula):

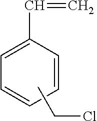

(1.13 equivalents relative to the hydroxyl group equivalent of P1) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 320 parts of toluene, and the mixture was washed with 240 parts of water until the pH of the aqueous layer reached 7. Thereafter, the solvent was distilled off under reduced pressure to obtain 185 parts of the polyfunctional vinyl resin (V1) as a toluene solution having a non-volatile content of 60%.

The hydroxyl group equivalent of the polyfunctional vinyl resin (V1) obtained was 17,200, the vinyl equivalent thereof was 430, and the total chlorine thereof was 420 ppm. It was the polyfunctional vinyl resin represented by the formula (1) wherein R¹ is a methyl group and i is 2. In GPC, the Mw was 3,020, the Mn was 1,050, the content of an n=0 form was 1.8% by area, the content of an n=1 form was 36.6% by area, and the content of an n≥2 form was 61.5% by area. In the formula (1), as for R², the group represented by the formula (2) derived from ethylvinylbenzene (one of R³ is an ethyl group) and the group represented by the formula (3) derived from divinylbenzene (all R³ are hydrogen atoms) coexist in a ratio almost the same as the mixing ratio of divinylbenzene as the raw material (20/80). In the formula (1a) that represents X, Ar is a benzene ring, and as for the position of the vinyl group, meta isomers (3-position) and para isomers (4-position) coexist in a ratio almost the same as the mixing ratio of chloromethylstyrene as the raw material (50/50).

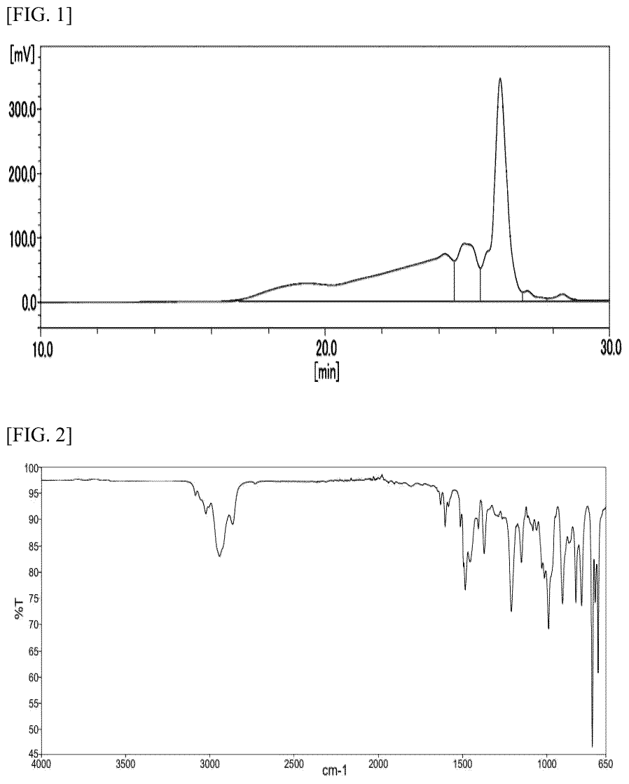

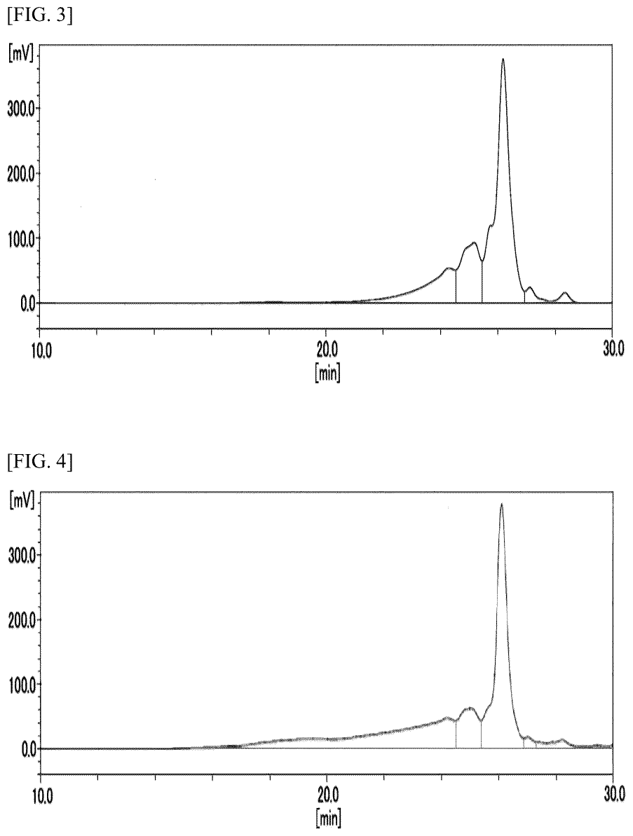

The GPC and the IR of the polyfunctional vinyl resin (V1) are respectively illustrated in FIG. 1 and FIG. 2.

### Example 2

The same apparatus as in Synthesis Example 1 was loaded with 100 parts of the polyvalent hydroxy resin (P2) obtained in Synthesis Example 3, 200 parts of toluene, 100 parts of dimethylsulfoxide, and 25 parts of methanol, and the temperature of the resulting mixture was raised to 60° C. for dissolution. 26.0 parts of 86% potassium hydroxide was added, and the mixture was further allowed to react at 60° C. for 1 hour. After the resulting mixture was cooled to 20° C., 62 parts of chloromethylstyrene (CMS-P manufactured by AGC SEIMI CHEMICAL CO., LTD., 3-position/4-position=50/50) (1.13 equivalents relative to the hydroxyl group equivalent of P2) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 320 parts of toluene, and the mixture was washed with 240 parts of water until the pH of the aqueous layer reached 7. Thereafter, the solvent was distilled off under reduced pressure to obtain 190 parts of the polyfunctional vinyl resin (V2) as a toluene solution having a non-volatile content of 60%.

The hydroxyl group equivalent of the polyfunctional vinyl resin (V2) obtained was 59,400, the vinyl equivalent thereof was 402, and the total chlorine thereof was 760 ppm. It was the polyfunctional vinyl resin represented by the formula (1) wherein R¹ is a methyl group and i is 2. In GPC, the Mw was 910, the Mn was 750, the content of an n=0 form was 3.9% by area, the content of an n=1 form was 56.6% by area, and the content of an n≥2 form was 39.5% by area. In the formula (1), as for R², the group represented by the formula (2) derived from ethylvinylbenzene (one of R³ is an ethyl group) and the group represented by the formula (3) derived from divinylbenzene (all R³ are hydrogen atoms) coexist in a ratio almost the same as the mixing ratio of divinylbenzene as the raw material (45/55). In the formula (1a) that represents X, Ar is a benzene ring, and as for the position of the vinyl group, meta isomers (3-position) and para isomers (4-position) coexist in a ratio almost the same as the mixing ratio of chloromethylstyrene as the raw material (50/50).

The GPC of the polyfunctional vinyl resin (V2) is illustrated in FIG. 2.

### Example 3

The same apparatus as in Synthesis Example 1 was loaded with 100 parts of the polyvalent hydroxy resin (P1) obtained in Synthesis Example 2, 200 parts of toluene, 100 parts of dimethylsulfoxide, and 25 parts of methanol, and the temperature of the resulting mixture was raised to 60° C. for dissolution. 23.7 parts of 86% potassium hydroxide was added, and the mixture was further allowed to react at 60° C. for 1 hour. After the resulting mixture was cooled to 20° C., 57 parts of chloromethylstyrene (CMS-14 manufactured by AGC SEIMI CHEMICAL CO., LTD., 3-position/4-position=5/95; the following structural formula):

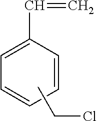

(1.13 equivalents relative to the hydroxyl group equivalent of P1) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 320 parts of toluene, and the mixture was washed with 240 parts of water until the pH of the aqueous layer reached 7. Thereafter, the solvent was distilled off under reduced pressure to obtain 186 parts of the polyfunctional vinyl resin (V3) as a toluene solution having a non-volatile content of 60%.

The hydroxyl group equivalent of the polyfunctional vinyl resin (V3) obtained was 23,500, the vinyl equivalent thereof was 429, and the total chlorine thereof was 550 ppm. It was the polyfunctional vinyl resin represented by the formula (1) wherein R¹ is a methyl group and i is 2. In GPC, the Mw was 2,980, the Mn was 1,030, the content of an n=0 form was 1.9% by area, the content of an n=1 form was 35.6% by area, and the content of an n≥2 form was 62.5% by area. In the formula (1), as for R², the group represented by the formula (2) derived from ethylvinylbenzene (one of R³ is an ethyl group) and the group represented by the formula (3) derived from divinylbenzene (all R³ are hydrogen atoms) coexist in a ratio almost the same as the mixing ratio of divinylbenzene as the raw material (20/80). In the formula (1a) that represents X, Ar is a benzene ring, and as for the position of the vinyl group, meta isomers (3-position) and para isomers (4-position) coexist in a ratio almost the same as the mixing ratio of chloromethylstyrene as the raw material (5/95).

The GPC of the polyfunctional vinyl resin (V3) is illustrated in FIG. 4.

### Comparative Example 1

The same apparatus as in Synthesis Example 1 was loaded with 100 parts of the polyvalent hydroxy resin (PH1) obtained in Synthesis Example 1, 200 parts of toluene, 100 parts of dimethylsulfoxide, and 25 parts of methanol, and the temperature of the resulting mixture was raised to 60° C. for dissolution. 36.8 parts of 86% potassium hydroxide was added, and the mixture was further allowed to react at 60° C. for 1 hour. After the resulting mixture was cooled to 20° C., 88 parts of chloromethylstyrene (1.13 equivalents relative to the hydroxyl group equivalent of PH1) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 370 parts of toluene, and the mixture was washed with 270 parts of water until the pH of the aqueous layer reached 7. Thereafter, the solvent was distilled off under reduced pressure to obtain 213 parts of the polyfunctional vinyl resin (VH1) as a toluene solution having a non-volatile content of 60%.

The hydroxyl group equivalent of the polyfunctional vinyl resin (VH1) obtained was 15,500, the vinyl equivalent thereof was 315, and the total chlorine was 1,580 ppm. In GPC, the Mw was 700, the Mn was 660, the content of an n=0 form was 1.5% by area, the content of an n=1 form was 87.1% by area, and the content of an n≥2 form was 11.4% by area.

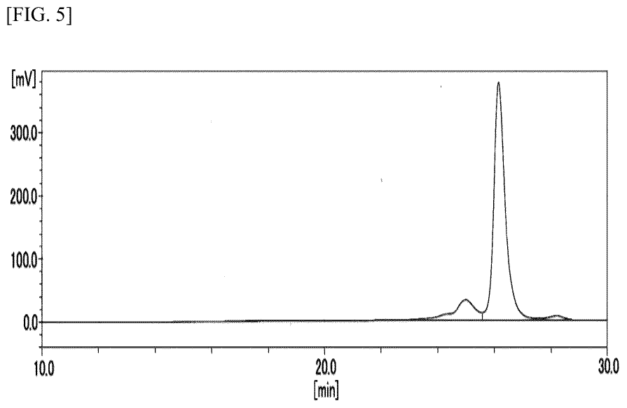

The GPC of the polyfunctional vinyl resin (VH1) is illustrated in FIG. 5.

### Comparative Example 2

The same apparatus as in Synthesis Example 1 was loaded with 100 parts of the polyvalent hydroxy resin (P3), 200 parts of toluene, 100 parts of dimethylsulfoxide, and 25 parts of methanol, and the temperature of the resulting mixture was raised to 60° C. for dissolution. 32.2 parts of 86% potassium hydroxide was added, and the mixture was further allowed to react at 60° C. for 1 hour. After the resulting mixture was cooled to 20° C., 77 parts of chloromethylstyrene (1.13 equivalents relative to the hydroxyl group equivalent of P3) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 320 parts of toluene, and the mixture was washed with 250 parts of water until the pH of the aqueous layer reached 7. Thereafter, the solvent was distilled off under reduced pressure to obtain 203 parts of the polyfunctional vinyl resin (VH2) as a toluene solution having a non-volatile content of 60%.

The hydroxyl group equivalent of the polyfunctional vinyl resin (VH2) obtained was 15,200, the vinyl equivalent thereof was 331, and the total chlorine was 1,680 ppm.

### Comparative Example 3

The same apparatus as in Synthesis Example 1 was loaded with 100 parts of the polyvalent hydroxy resin (P4), 200 parts of toluene, 100 parts of dimethylsulfoxide, and 25 parts of methanol, and the temperature of the resulting mixture was raised to 60° C. for dissolution. 68.4 parts of 86% potassium hydroxide was added, and the mixture was further allowed to react at 60° C. for 1 hour. After the resulting mixture was cooled to 20° C., 164 parts of chloromethylstyrene (1.13 equivalents relative to the hydroxyl group equivalent of P4) was dropped for 1 hour, and the mixture was further allowed to react at 60° C. for 3 hours. The absence of chloromethylstyrene was confirmed by gas chromatography, and the solvent was recovered under reduced pressure. The resin obtained was dissolved in 490 parts of toluene, and the mixture was washed with 330 parts of water until the pH of the aqueous layer reached 7. Thereafter, the solvent was distilled off under reduced pressure to obtain 280 parts of the polyfunctional vinyl resin (VH3) as a toluene solution having a non-volatile content of 60%.

The hydroxyl group equivalent of the polyfunctional vinyl resin (VH3) obtained was 12,200, the vinyl equivalent thereof was 235, and the total chlorine was 2,700 ppm.

### Example 4

Components were mixed in a compounding ratio (parts) shown in Table 1 and dissolved in the solvent to thereby obtain a uniform vinyl resin composition varnish. A glass cloth (WEA 7628 XS13 manufactured by Nitto Boseki Co., Ltd., 0.18 mm in thickness) was impregnated with the vinyl resin composition varnish obtained. The glass cloth impregnated was dried in a hot air oven at 130° C. for 5 minutes, to thereby obtain a prepreg. Eight of the prepregs obtained and copper foil (3EC-III manufactured by Mitsui Mining & Smelting Co., Ltd., thickness 35 μm) were stacked with the copper foil being located on and below the prepregs, and the resulting stacked product was pressed in vacuum at 2 MPa in temperature conditions of 130° C.×30 minutes+220° C.×100 minutes, to thereby obtain a laminated board having a thickness of 1.6 mm. The results of the copper foil peel strength and Tg of the laminated board are shown in Table 1.

A PET film was coated with the vinyl resin composition varnish and dried at 130° C. for 5 minutes, and the dried varnish was peeled from the PET film to obtain a resin composition. The resin composition obtained was placed into a fluororesin mold, and pressed in vacuum at 2 MPa in temperature conditions of 130° C.×30 minutes+220° C.×100 minutes, to thereby obtain a test piece of 50 mm square×2 mm thickness. The results of the relative permittivity and dielectric tangent in the test piece are shown in Table 1.

### Examples 5 to 7 and Comparative Examples 4 to 7

Each vinyl resin composition varnish, prepreg, laminated board, vinyl resin composition, and test piece were obtained by compounding at each amount of compounding (parts) in Table 1 and by the same operations performed as in Example 4. The same test as in Example 4 was performed. The results are shown in Table 1.

TABLE 1

| | Exam- | Exam- | Exam- | Exam- | Comparative | Comparative | Comparative | Comparative |
|---|---|---|---|---|---|---|---|---|
| | ple 4 | ple 5 | ple 6 | ple 7 | Example 4 | Example 5 | Example 6 | Example 7 |
| V1 | 100 | | | 50 | | | | |
| V2 | | 100 | | | | | | |
| V3 | | | 100 | | | | | |
| VH1 | | | | 50 | 100 | | | |
| VH2 | | | | | | 100 | | |
| VH3 | | | | | | | 100 | |
| VH4 | | | | | | | | 100 |
| PO | 0.50 | 0.50 | 0.50 | 0.50 | 0.50 | 0.50 | 0.50 | 0.50 |
| AO | 0.20 | 0.20 | 0.20 | 0.20 | 0.20 | 0.20 | 0.20 | 0.20 |
| Copper | 0.50 | 0.51 | 0.49 | 0.49 | 0.42 | 0.39 | 0.41 | 0.34 |
| foil peel | | | | | | | | |
| strength | | | | | | | | |
| (kN/m) | | | | | | | | |
| Tg(° C.) | 256 | 260 | 258 | 270 | 284 | 265 | 290 | 198 |
| Relative | 2.60 | 2.60 | 2.61 | 2.60 | 2.61 | 2.73 | 2.79 | 2.61 |
| permittivity | | | | | | | | |
| Dielectric | 0.0028 | 0.0031 | 0.0029 | 0.0031 | 0.0036 | 0.0036 | 0.0081 | 0.0031 |
| tangent | | | | | | | | |

The polyfunctional vinyl resins in Examples exhibited excellent physical properties of high adhesion force, low relative permittivity, and low dielectric tangent as compared with Comparative Examples. In addition, each of them obtained a Tg of 250° C. or more. Thus, it was demonstrated that each resin had sufficient heat resistance.

### INDUSTRIAL APPLICABILITY

The polyfunctional vinyl resin and composition of the present invention can be used as dielectric materials, insulation materials, and heat-resistant materials in the fields of electrical and electronic industries, space and aircraft industries, and the like, can be particularly utilized as printed substrates, sealing materials, casting materials, and the like in electronic devices, and are especially useful as electronic materials in high-speed telecommunication equipment.

1. A polyfunctional vinyl resin represented by the following general formula (1): 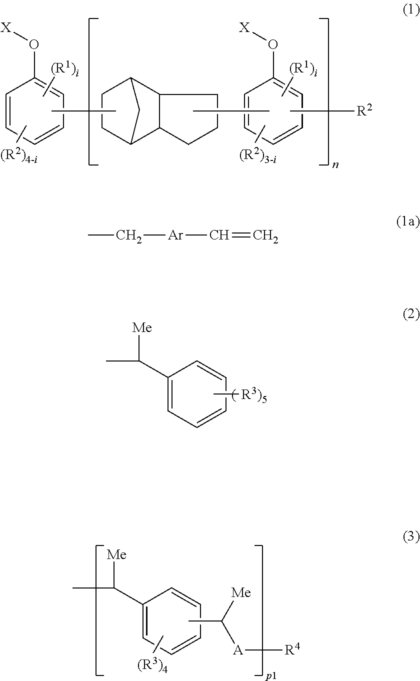
wherein each R¹ independently represents a hydrocarbon group having 1 to 8 carbon atoms, each R² independently represents a hydrogen atom, a group represented by formula (2), or a group represented by formula (3), and at least one R² is represented by formula (2) or formula (3); each R³ independently represents a hydrogen atom or a hydrocarbon group having 1 to 8 carbon atoms, and each R⁴ independently represents a hydrogen atom or a group represented by formula (2); A represents a residue obtained by removing two R² from the formula (1) and each R² in the residue independently represents a hydrogen atom or a group represented by formula (2); Me represents a methyl group; each X independently represents a hydrogen atom or a vinyl group-containing aromatic group represented by the formula (1a), at least one is a vinyl group-containing aromatic group, and Ar represents an aromatic ring; i is an integer of 0 to 2; and each of n and p 1 represents the number of repetitions and an average value thereof is a number of 0 to 5.

2. The polyfunctional vinyl resin according to claim 1, wherein Ar in the formula (1a) is an aromatic ring selected from the group consisting of a benzene ring, a naphthalene ring, and a biphenyl ring, and the aromatic ring Ar is unsubstituted or has one or more substituents.

3. The polyfunctional vinyl resin according to claim 1, wherein R¹ is a methyl group or a phenyl group, and i is 1 or 2.

4. The polyfunctional vinyl resin according to claim 1, wherein the polyfunctional vinyl resin is obtained by vinylation of a polyvalent hydroxy resin represented by the following general formula (4): 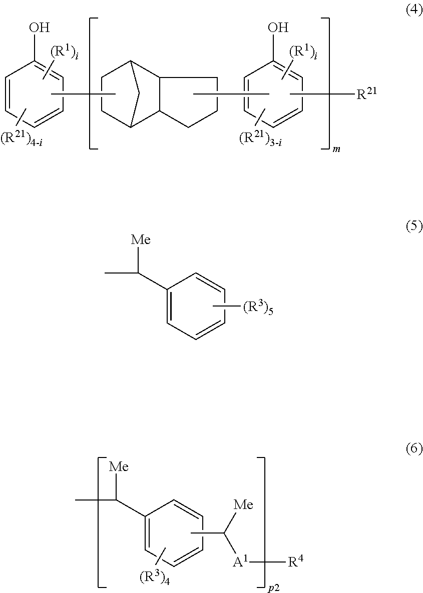
wherein each R¹ independently represents a hydrocarbon group having 1 to 8 carbon atoms, each R²¹ independently represents a hydrogen atom, a group represented by formula (5), or a group represented by formula (6), and at least one is formula (5) or formula (6); each R³ independently represents a hydrogen atom or a hydrocarbon group having 1 to 8 carbon atoms, and each R⁴ independently represents a hydrogen atom or a group represented by formula (5); A¹ represents a residue obtained by removing two R²¹ from the formula (4) and each R²¹ in the residue independently represents a hydrogen atom or a group represented by formula (5); Me represents a methyl group; i is an integer of 0 to 2; and each of m and p2 represents the number of repetitions and an average value thereof is a number of 0 to 5.

5. A polyfunctional vinyl resin composition comprising the polyfunctional vinyl resin according to claim 1 and a radical polymerization initiator as essential components.

6. A cured product obtained by curing the polyfunctional vinyl resin according to claim 1 or the polyfunctional vinyl resin composition according to claim 5.

7. A prepreg comprising the polyfunctional vinyl resin composition according to claim 5 or a semi-cured product thereof, and a fibrous base material.

8. A resin sheet comprising a resin layer of the polyfunctional vinyl resin composition according to claim 5 or a semi-cured product thereof, and a support film.

9. A laminated board formed by lamination of the prepreg according to claim 7 and/or a resin sheet comprising a resin layer of the polyfunctional vinyl resin composition.

10. A method for producing the polyfunctional vinyl resin according to claim 1, comprising reacting a polyvalent hydroxy resin represented by the following general formula (4) and a halogenated methyl group-containing aromatic vinyl compound represented by the following general formula (10): 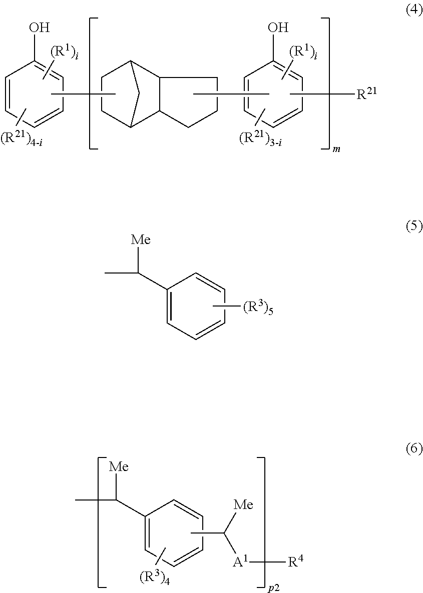
wherein each R¹ independently represents a hydrocarbon group having 1 to 8 carbon atoms, each R²¹ independently represents a hydrogen atom, a group represented by formula (5), or a group represented by formula (6), and at least one is formula (5) or formula (6); each R³ independently represents a hydrogen atom or a hydrocarbon group having 1 to 8 carbon atoms, and each R⁴ independently represents a hydrogen atom or a group represented by formula (5); A¹ represents a residue obtained by removing two R²¹ from the formula (4) and each R²¹ in the residue independently represents a hydrogen atom or a group represented by formula (5); Me represents a methyl group; i is an integer of 0 to 2; and each of m and p2 represents the number of repetitions and an average value thereof is a number of 0 to 5: 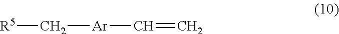
wherein Ar represents an aromatic ring, and R⁵ represents a halogen.

11. The method for producing the polyfunctional vinyl resin according to claim 10, wherein Ar in the formula (10) is an aromatic ring selected from the group consisting of a benzene ring, a naphthalene ring, and a biphenyl ring, and the aromatic ring Ar is unsubstituted or has one or more substituents.

12. The method for producing the polyfunctional vinyl resin according to claim 10, wherein R¹ in the formula (4) is a methyl group or a phenyl group, and i is 1 or 2.
